(19) United States
(12) Patent Application Publication
(10) Pub. No.: US 2026/0121431 A1
(43) Pub. Date: Apr. 30, 2026

(54) ELECTRONIC DEVICE AND METHOD FOR DETERMINING CHARGING CONDUCTIVITY

(71) Applicant: Harman International Industries, Incorporated, Stamford, CT (US)

(72) Inventors: Yi ZHANG, Shenzhen (CN); Bin CAI, Guangdong (CN)

(73) Assignee: Harman International Industries, Incorporated, Stamford, CT (US)

(21) Appl. No.: 19/474,871

(22) Filed: Oct. 13, 2025

Related U.S. Application Data
(63) Continuation of application No. PCT/CN2023/088073, filed on Apr. 13, 2023.

(51) Int. Cl. H02J 7/80; G08B 21/18; H01M 10/44; H02J 7/90; H02J 7/96; H04R 1/10; H04R 1/1025; H04R 5/033; H04R 29/00

(52) U.S. Cl. CPC H02J 7/80; G08B 21/182; G08B 21/185; H01M 10/44; H02J 7/933; H02J 7/96; H04R 1/1016; H04R 1/1025; H04R 5/033; H04R 29/001; H04R 2420/07

(57) ABSTRACT

An electronic device includes a charging circuit and a bypass circuit. The charging circuit adapted to charge a battery of the electronic device. The bypass circuit is connected in parallel with the charging circuit. A controller is configured to selectively turn on or turn off the bypass circuit with a first switch connected in series with the bypass circuit and to selectively turn on or turn off the charging circuit with a second switch connected in series with the charging circuit. The controller further configured to: measure a first voltage from upstream of the charging circuit with both the bypass circuit and the charging circuit being turned off; measure a second voltage from upstream of the charging circuit with the bypass circuit being turned on and the charging circuit being turned off; compare the first voltage with the second voltage; and determine a charging conductivity based on the comparison result.

### CROSS-REFERENCE TO RELATED APPLICATIONS

This application is a continuation of International Application No. PCT/CN2023/088073, filed on Apr. 13, 2023. The disclosure of the above application is incorporated herein by reference.

### FIELD

The present disclosure relates to an electronic device and a method for determining a conductivity of the electronic device. Specifically, the present disclosure relates to TWS earbuds and a method for determining a conductivity of the TWS earbuds.

### BACKGROUND

The statements in this section merely provide background information related to the present disclosure and may not constitute prior art.

True Wireless Stereo (TWS) earbuds have become more and more popular as everyday items for users worldwide. The earbuds are commonly used for various activities, including making phone calls, playing games, watching TV, or enjoying short videos during commutes. TWS earbuds and their charging case typically include charging contacts or pins that are exposed externally to facilitate smooth charging when the TWS earbuds are placed in the charging case. These charging contacts or pins are usually coated with metal materials such as gold, silver, or nickel, to enhance durability and conductivity. However, this design also has several drawbacks.

During use, the charging contacts or pins of the TWS earbuds or the charging case may encounter various undesirable conditions. For instance, the metal materials coating the charging contacts or pins may be susceptible to oxidation when exposed to air or humid environments for extended periods. This oxidation may reduce the metal's conductivity and wear resistance, negatively affecting the charging efficiency of TWS earbuds. Moreover, the exposed charging pins may accumulate dust, dirt, and other impurities, which may hinder their charging performance. Additionally, the externally exposed charging contacts or pins are susceptible to damage from liquids, such as water or sweat. Prolonged exposure or lack of cleaning may result in corrosion or short-circuiting of the charging pins, effecting their charging efficiency and overall lifespan. It is vital for users to be aware of these unfavorable conditions and take appropriate action, such as cleaning the charging contacts or pins of the earbuds and/or the charging case.

Therefore, there is a need for TWS earbuds or an electronic device that are capable of determining or detecting and/or notifying the user about the undesirable conditions of the charging contacts or pins.

### SUMMARY

This section provides a general summary of the disclosure and is not a comprehensive disclosure of its full scope or all of its features.

According to one aspect of the disclosure, an electronic device is provided, comprising: a charging circuit adapted to receive a charging voltage from an external charging device, and to charge a battery of the electronic device with the received charging voltage; a bypass circuit connected in parallel with the charging circuit, the bypass circuit comprising a resistor; and a controller configured to selectively turn on or turn off the bypass circuit with a first switch connected in series with the bypass circuit and to selectively turn on or turn off the charging circuit with a second switch connected in series with the charging circuit. The controller being further configured to: measure a first voltage from upstream of the charging circuit with both the bypass circuit and the charging circuit being turned off; measure a second voltage from upstream of the charging circuit with the bypass circuit being turned on and the charging circuit being turned off; compare the first voltage with the second voltage; and determine a charging conductivity based on the comparison result.

According to another aspect of the disclosure, a method for determining a charging conductivity of an electronic device is provided. The method comprises the steps of: providing an electronic device comprising a charging circuit, a bypass circuit having a resistor and connected in parallel with the charging circuit, and a controller configured to selectively turn off or turn on the charging circuit and the bypass circuit; receiving a charging voltage from an external charging device by the electronic device; measuring a first voltage from upstream of the charging circuit with both the charging circuit and the bypass circuit being turned off; measuring a second voltage from upstream of the charging circuit with the charging circuit being turned off and the bypass circuit being turned on; comparing the first voltage with the second voltage; determining the charging conductivity based on the comparison result.

Other systems, methods, features and advantages of the disclosure will become apparent to those skilled in the art upon reading of the following figures and detailed description. It is intended that all such additional systems, methods, features, and advantages be included in this description, fall within the scope of the disclosure, and be protected by the accompanying claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The present disclosure will be better understood by reference to the following drawings and description. The components shown in the drawings are not necessarily to scale, instead, emphasis should be placed upon the principles illustrated by the disclosure. Moreover, in the figures, like reference numerals designate like parts throughout the drawings.

FIG. 1A is a block diagram of an earbud assembly according to one or more embodiments of the present disclosure in accordance with the principles of the present disclosure;

FIG. 1B is a schematic diagram, showing the current flow of the earbud assembly depicted in FIG. 1A;

FIG. 2 shows a perspective view of an earbud assembly according to one or more embodiments of the present disclosure;

FIG. 3 is a block diagram of an electronic device assembly according to one or more embodiments of the disclosure;

FIG. 4A shows a flowchart of a method according to one or more embodiments of the present disclosure;

FIG. 4B shows a flowchart of a method of the step S46 according to one or more embodiments of the present disclosure; and

FIG. 4C shows a flowchart of a method of the step S46 according to one or more further embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, various embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes” and/or “including”, as used herein, specify the presence of stated features, integers, steps, operations, elements, and/or components, but do not preclude the presence or addition of one or more other features, integers, steps, operations, elements, components, and/or combinations thereof. As used herein, the term “and/or” and the symbol “/” are meant to include any and all combinations of one or more of the associated listed items. Additionally, while the terms first, second etc., may be used herein to describe various elements, components, steps or calculations, these elements, components, steps, or calculations should not be limited by these terms, rather, these terms are only used to distinguish one element, component, step or calculation from another. For example, a first component may be referred to as a second component, similarly a first calculation may be referred to as a second calculation; likewise, a first step may be referred to as a second step, all without departing from the scope of this disclosure.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The present disclosure provides an electronic device and a method for determining a charging conductivity of an electronic device. The electronic device comprises a charging circuit adapted to receive a charging voltage from an external charging device to charge a battery of the electronic device; a bypass circuit connected in parallel with the charging circuit; and a controller configured to selectively turn on or turn off the bypass circuit and to selectively turn on or turn off the charging circuit. The controller is further configured to: measure a first voltage upstream of the charging circuit with both the bypass circuit and the charging circuit being turned off; measure a second voltage upstream of the charging circuit with the bypass circuit being turned on and the charging circuit being turned off; compare the first voltage with the second voltage; and determine a charging conductivity based on the comparison result. By providing a bypass circuit, the electronic device and method of the present disclosure can determine a charging conductivity of the electronic device based on different voltages measured upstream of the charging circuit with the bypass circuit being turned on and off.

In one or more embodiments of the present disclosure, a different indication or notification is provided to inform the user of the electronic device about the charging conductivity of the electronic device. When the user becomes aware of an unfavorable condition of the charging conductivity, he or she may take appropriate action, such as cleaning the charging contacts of the electronic device and/or charging device.

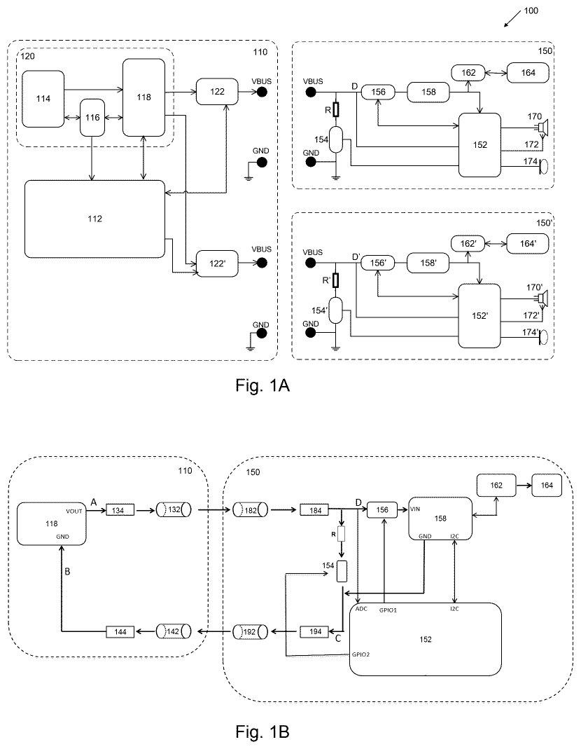

FIG. 1A is a block diagram of an earbud assembly 100 according to one or more embodiments of the present disclosure. The earbud assembly 100 comprises a charging case 110 and a pair of earbuds 150, 150′. The pair of earbuds 150, 150′ may be stowed and charged within the charging case 110 when not in use. As shown, the charging case 110 comprises a controller 112, a power source module 120, a pair of switches 122, 122′, and two sets of contacts each comprising two contacts, VBUS and GND. The power source module 120 comprises a charger element 114, a battery 116 and a charger IC 118. The earbud 150 comprises a controller 152, a charging circuit, a bypass circuit, and two contacts, i.e., VBUS and GND. The bypass circuit is connected in parallel with the charging circuit and comprises a resistor R and a first switch 154 electrically connected in series between the two contacts of the earbud 150. The charging circuit is electrically connected to the contact VBUS and comprises a second switch 156, a charger IC 158, a protection IC 162, and a battery 164. Although not shown in the figure, a skilled person in the art would understand that at least one of the charger IC 158 and the protection IC 162 is grounded. The earbud 150 further comprises a speaker 170, an antenna 172, and a microphone 174 connected to the controller 152. The earbud 150′ comprises a controller 152′, a charging circuit, a bypass circuit, and two contacts, i.e., VBUS and GND. The bypass circuit is connected in parallel with the charging circuit and comprises a resistor R′ and a first switch 154′ electrically connected in series between the two contacts of the earbud 150′. The charging circuit is electrically connected to the contact VBUS and comprises a second switch 156′, a charger IC 158′, a protection IC 162′ and a battery 164′. The earbud 150′ further comprises a speaker 170′, an antenna 172′ and a microphone 174′, all connected to the controller 152′.

When the earbud 150 is stowed in the charging case 110, each of the contacts VBUS and GND of the earbud 150 comes into contact with, and thus establishes an electrical connection to a corresponding contact in the first set of contacts VBUS and GND of the charging case 110. As a result, a power line or power connection between the charging case 110 and the earbud 150 is established. The charging circuit of earbud 150 receives charging voltage or current from the charging case 110 via the established power line or power connection and charges the battery 164 using the received charging voltage or current via the power line or power connection. The controller 152 is electrically connected to the first switch 154 and configured to selectively turn on or turn off the first switch 154, thereby selectively turning the bypass circuit on or off. The controller 152 is electrically connected to the second switch 156 and configured to selectively turn on or turn off the second switch 156, thereby selectively turning the charging circuit on or off. The controller 152 is also electrically connected to point D, which is located near the contact VBUS and upstream of the charging circuit and/or the bypass circuit. The controller is configured to selectively measure or read the voltage at point D.

When the earbud 150′ is stowed in the charging case 110, each of the contacts VBUS and GND of the earbud 150′ becomes into contact with and thus establishes an electrical connection to a corresponding contact in the second set of contacts VBUS and GND of the charging case 110. As a result, a power line or power connection between the charging case 110 and the earbud 150′ is established. The charging circuit of earbud 150′ receives charging voltage or current from the charging case 110 via the established power line or power connection and charges the battery 164′ using the received charging voltage or current via the power line or power connection. The controller 152′ is electrically connected to the first switch 154′ and configured to selectively turn on or turn off the first switch 154′, thereby selectively turning the bypass circuit on or off. The controller 152′ is electrically connected to the second switch 156′ and configured to selectively turn on or turn off the second switch 156′, whereby selectively turning the charging circuit on or off. The controller 152′ is also electrically connected to point D′ which is located near the contact VBUS and upstream of the charging circuit and/or the bypass circuit. The controller is configured to selectively measure or read the voltage at point D′.

During operation, after the earbud 150 is stowed in the charging case 110, the earbud assembly 100 enters a determining process or phase. In one or more embodiments of the present disclosure, the determining process or phase may last for a predetermined time period, such as 3 seconds or 5 seconds. During the determining process or phase, the charging case 110 provides a constant voltage, such as 5V, to the earbud 150 through its corresponding contacts VBUS and GND. The controller 152 of the earbud 150 first sends signals to the first switch 154 and the second switch 156 to turn off the first switch 154 and the second switch 156. With the first switch 154 and the second switch 156 being turned off, the charging circuit of earbud 150 is electrically disconnected from the contact VBUS, and the contact VBUS and the contact GND are not electrically connected through the bypass circuit. The controller 152 then measures a first voltage from point D, which is upstream of the charging circuit and/or the bypass circuit. After measuring the first voltage, the controller 152 sends a signal to turn on the first switch 154. With the first switch 154 on and the second switch 156 off, the charging circuit of earbud 150 remains electrically disconnected from the contact VBUS, and the contact VBUS and the contact GND are electrically connected through the bypass circuit. The controller 152 subsequently measures a second voltage from point D. After measuring both the first voltage and the second voltage, the controller 152 compares the first voltage with the second voltage, for example by subtracting the second voltage from the first voltage, and determines the conductivity between the charging case 110 and the earbud 150 based on the comparison result. In one or more embodiments of the present disclosure, the conductivity between the charging case 110 and the earbud 150 may be determined to be in a first condition (favorable condition) if the difference between the first voltage and the second voltage is no larger than a first threshold. The conductivity between the charging case 110 and the earbud 150 may be determined to be in a second condition (less favorable condition) if the difference between the first voltage and the second voltage is larger than the first threshold but no larger than a second threshold which is larger than the first threshold. The conductivity between the charging case 110 and the earbud 150 may be determined to be in a third condition (poor condition) if the difference between the first voltage and the second voltage is larger than the second threshold. In one or more embodiments of the present disclosure, the first condition may indicate that the contacts VBUS and GND of the earbud 150 and the corresponding contacts of the charging case 110 are in good condition. The second condition may indicate that the contacts VBUS and GND of the earbud 150 and the corresponding contacts of the charging case 110 are oxidized, or corroded or have stain, and need a cleaning. The third condition may indicate that the contacts VBUS and GND of the earbud 150 and the corresponding contacts of the charging case 110 are seriously oxidized, or corroded or have stain, and need an immediate cleaning.

In one or more embodiments of the present disclosure, the earbud assembly 100 enters a normal charging process or phase after the determining process or phase. To initiate the normal charging process, the controller 152 sends signals to turn off the first switch 154 and turn on the second switch 156, so that the bypass circuit is cut off or turned off, and the charging circuit is electrically connected to the contact VBUS of the earbud and thus is activated to charge the battery 164 of the earbud 150.

The operation of the earbud 150′ may be similar to that of the earbud 150, and detailed description thereof therefore is omitted.

In one or more embodiments of the present disclosure, the earbud assembly 100 may provide a first indication or notification when the charging conductivity between the charging case 110 and the earbud 150 and/or the earbud 150′ is determined to be in the first condition. The earbud assembly 100 may provide a second indication or notification when the charging conductivity between the charging case 110 and the earbud 150 and/or the earbud 150′ is determined to be in the second condition. The earbud assembly 100 may provide a third indication or notification when the charging conductivity between the charging case 110 and the earbud 150 and/or the earbud 150′ is determined to be in the third condition. In one or more embodiments of the present disclosure, the first indication may be a green light emitted by an indication light on the electronic device or the charging device, the second indication may be a yellow light emitted by the indication light, and the third indication may be a red light emitted by the indication light. In one or more embodiments of the present disclosure, the first indication, the second indication and the third indication may be a green indication, a yellow indication, and a red indication displayed on an APP of the user of the earbud assembly.

In one or more embodiments of the present disclosure, the first switch 154 is an N-type MOS and the second switch 156 is a P-type MOS. This configuration is advantageous as the controller 152 only needs to output a low voltage signal to the first and second switches during the normal charging process, which is energy efficient. This is also advantageous as the earbud 150 may directly enter the normal charging process when battery 164 of the earbud 150 is completely exhausted.

In the one or more embodiments described above, the determining process or phase is performed immediately after the earbuds 150, 150′ are stowed in the charging case 110. In one or more other embodiments, the determining process or phase may be performed at any suitable time, such as during a charging process or at the end of a charging process. The determining process or phase may also be performed periodically with any suitable periodicity, such as once a day or once every two days.

In the one o more embodiments described above, the first voltage is measured before the second voltage. In one or more other embodiments, the second voltage may be measured before the first voltage. In this scenario, the controller first sends signals to the first switch 154 and the second switch 156 to turn on the first switch 154 and to turn off the second switch 156 and then measures the second voltage with the first switch 154 being on and the second switch 156 being off. After measuring the second voltage, the controller sends a signal to the first switch 154 to turn off the first switch 154 and then measures the first voltage with both the first switch 154 and the second switch 156 being off.

In the one or more embodiments shown in FIG. 1A, the charging case 110 and the earbuds 150, 150′ have a specific structure. The present disclosure is not limited thereto and in one or more other embodiments of the present disclosure, the charging case and the earbuds may have any suitable structure as long as the earbuds have a bypass circuit that is connected in parallel with the charging circuit so that the earbud assembly can perform a determining process to determine a charging conductivity.

FIG. 1B is a schematic diagram, showing the current flow of the earbud assembly 100 depicted in FIG. 1A. For simplicity, one earbud 150′ and certain components, such as the controller 112, the charger element 114, and the battery 116 of the charging case 110, as well as the speaker 170, the antenna 172, and the microphone 174 of the earbud 150 are not shown. The charging contacts VBUS and GND of the charging case 110 and the earbuds may be a pogo pin, shrapnel, or copper cylinder, with an impedance no larger than 0.05Ω when charging contacts are in a good condition. However, the impedance of the charging contacts may increase due to poor contact between the contacts caused by oxidation or corrosion, or the presence of dust, dirt, and other impurities on the contacts.

The earbud assembly 100 has a Ferrite bead for ESD (Electro-Static discharge) protection adjacent to each of the charging contacts VBUS and GND. Normally, the Ferrite bead is a 0Ω resistor when it is in good condition. However, the Ferrite bead may have an increased impedance when it fails or is damaged.

In FIG. 1B, elements or resistors 132, 142, 182, 192 are used to represent the impedances of the charging contacts, and elements or resistors 134, 144, 184, 194 are used to represent the impedances of the Ferrite beads. When the controller 152 measures the first voltage from point D, both the first switch 154 and the second switch 156 are turned off. Consequently, there is no current between point A and point D or between point B and point C, resulting in no voltage drop between point A and point D or between point B and point C. Therefore, the first voltage taken by the controller 152 from point D may correspond to or be equal to the voltage output from the charger IC 118, i.e., the voltage between point A and point B.

When the controller measures the second voltage from point D, the first switch 154 is turned on and the second switch 156 remains off. Consequently, a current from the charger IC 118 flows through the elements 134, 132, 182, 184, and then flows through the resistor R, the first switch 154, the elements 194, 192, 142, 144. Therefore, the second voltage taken by the controller 152 from point D may correspond to or be equal to the voltage output from the charger IC 118 minus the voltage drop between point A and D and the voltage drop between point C and B.

Since the charger IC 118 outputs a constant voltage during the determining process or phase, the difference between the first voltage and the second voltage may correspond to or be equal to the voltage drop across elements 134, 132, 182, 184, 194, 192, 142, and 144 when measuring the second voltage. Thus, the difference between the first voltage and the second voltage may be used to indicate the charging conductivity between the charging case 110 and the earbud 150. In one or more embodiments of the present disclosure, the charging conductivity between the charging case 110 and the earbud 150, 150′ may be determined to be in the first condition if the difference between the first voltage and the second voltage is no larger than a first threshold. The charging conductivity may be determined to be in the second condition if the voltage difference is larger than the first threshold, but no larger than a second threshold. The conductivity may be determined to be in the third condition if the voltage difference is larger than the second threshold. In one or more embodiments of the present disclosure, the first threshold may be about two percent of the constant voltage output by the charger IC 118 during the determining process or phase, and the second threshold may be about eight percent of the constant voltage output by the charger IC 118 during the determining process or phase. In one or more embodiments of the present disclosure, the first threshold may be about one to three percent of the constant voltage output by the charger IC 118 during the determining process or phase, and the second threshold may be six to ten percent of the constant voltage output by the charger IC 118 during the determining process or phase.

In one or more embodiments of the present disclosure, a total impedance of elements 134, 132, 182, 184, 194, 192, 142, and 144 (also referred to as a path impedance) may be calculated to indicate the charging conductivity between the charging case 110 and the earbud 150. Normally, the impedance of the resistor R is much larger than the total impedance of elements 134, 132, 182, 184, 194, 192, 142, and 144, so the current flowing through the elements 134, 132, 182, 184, 194, 192, 142, and 144 may be approximately equal to the voltage output from the charging circuit divided by the impedance of the resistor R. The total impedance of elements 134, 132, 182, 184, 194, 192, 142, 144 may be Rpath=(VIN1−VIN2)/I, wherein VIN1 is the first voltage measured by the controller from point D and VIN2 is the second voltage measured by the controller from point D.

In one or more embodiments of the present disclosure, the charging conductivity between the charging case 110 and the earbud 150, 150′ may be determined to be in the first condition if the calculated total impedance is no larger than a first threshold. The charging conductivity may be determined to be in the second condition if the calculated total impedance is larger than the first threshold, but no larger than a second threshold. The charging conductivity may be determined to be in the third condition if the calculated total impedance is larger than the second threshold. In one or more embodiments, the charger IC 118 outputs a constant voltage of 5V during the determining process or phase and the resistor R has an impedance of 25Ω. The first threshold is 0.5Ω and the second threshold is 2Ω. In one or more other embodiments of the present disclosure, the charger IC 118 outputs a constant voltage of 3-6V during the determining process or phase and the resistor R has an impedance of 15-30Ω. The first threshold is 0.3-0.6Ω and the second threshold is 1.5-2.5Ω.

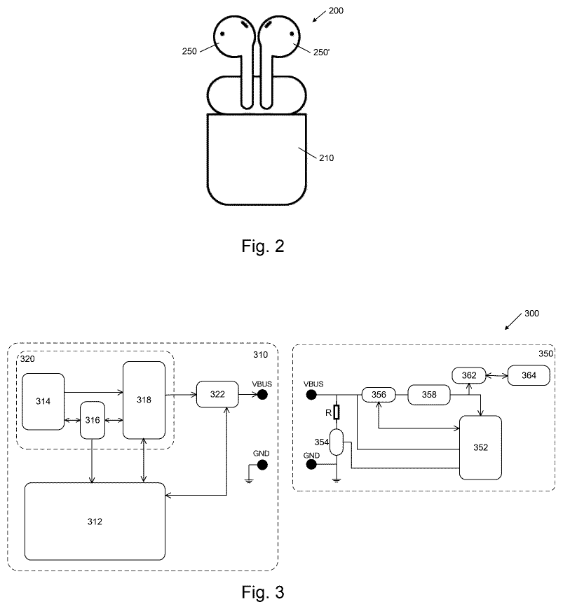

FIG. 2 shows a perspective view of an earbud assembly 200 according to one or more embodiments of the present disclosure. The earbud assembly 200 comprises a charging case 210 and a pair of earbuds 250, 250′. The earbuds 250, 250′ may be stowed in and charged by the charging case 210 when not in use. The earbud assembly 200 shown in FIG. 2 may have a circuit structure similar to the earbud assembly 100 shown in FIG. 1A-1B, and a detailed description about the circuit structure and operation thereof is omitted. The charging case and earbuds shown in FIG. 2 are merely illustrative, and the present disclosure is not limited thereto. In one or more other embodiments according to the present disclosure, the charging case and earbuds may have any suitable appearance, shape, or configuration.

The present disclosure has been discussed in connection with earbud assemblies shown in FIGS. 1A-1B and 2. However, the present disclosure is not limited to earbud assemblies. In one or more embodiments, the present disclosure may be applicable to a wearable device assembly or any suitable electronic device assembly. The wearable device of the present disclosure may be, e.g., a smart watch, a smart bracelet, or smart glasses. The electronic device assembly may be any suitable assembly that comprises an electronic device and a charging device for charging the electronic device via charging contacts.

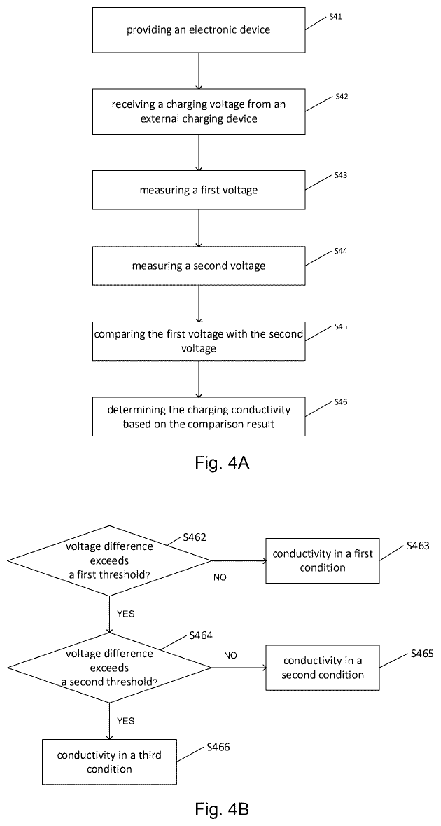

FIG. 3 is a block diagram of an electronic device assembly 300 according to one or more embodiments of the disclosure. The electronic device assembly 300 comprises an electronic device 350 and a charging device 310 for charging the electronic device 350. As shown, the charging device 310 comprises a controller 312, a power source module 320, and a switch 322, and a set of contacts comprising two contacts, VBUS and GND. The power source module 320 comprises a charger element 314, a battery 316 and a charger IC 318. The electronic device 350 comprises a controller 352, a charging circuit, a bypass circuit, and two contacts, i.e., VBUS and GND. The bypass circuit is connected in parallel with the charging circuit and comprises a resistor R and a first switch 354 electrically connected in series between the two contacts of the electronic device 350. The charging circuit is electrically connected to the contact VBUS and comprises a second switch 356, a charger IC 358, a protection IC 362, and a battery 364.

Elements and operations of the one or more embodiments shown in FIG. 3 may be similar or the same to those of the embodiments shown in FIGS. 1A-1B and 2, and thus detailed description therefor is omitted.

In the one or more embodiments shown in FIG. 3, the electronic device assembly comprises a charging device and one electronic device. However, the present disclosure is not limited thereto. In one or more other embodiments of the present disclosure, the electronic device assembly may comprise more than one electronic device, such as two electronic devices or three electronic devices. In one or more further embodiments, the electronic device assembly may be a wearable device assembly comprising a wearable device and a charging device for charging the wearable device.

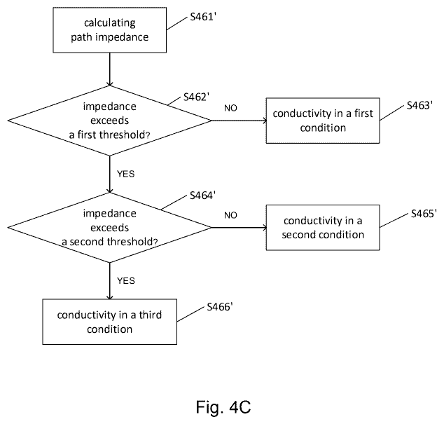

FIG. 4A shows a flowchart of a method according to one or more embodiments of the present disclosure. The process begins at S41, where an electronic device is provided. The electronic device may comprise a charging circuit for charging a battery of the electronic device, a bypass circuit having a resistor and connected in parallel with the charging circuit, and a controller configured to selectively turn on or off the charging circuit and the bypass circuit. In one or more embodiments of the present disclosure, the electronic device may comprise a first switch connected in series with the bypass circuit and a second switch connected in series with the charging circuit. The controller is configured to selectively turn on or turn off the first switch, thereby turning on or turn off the bypass circuit, and to turn on or turn off the second switch, thereby turning on or cut off the charging circuit. In one or more embodiments of the present disclosure, the electronic device provided in S41 may be an electronic device shown in FIGS. 1A-1B, 2, and 3.

The process then proceeds to S42, where the electronic device receives a charging voltage or current from an external charging device. In one or more embodiments of the present disclosure, the external charging device may be configured to supply a constant charging voltage to the electronic device. This constant charging voltage may last for a predetermined time period, allowing the steps of S43 and S44 to be performed within the time period.

The process then proceeds to S43, where the controller of the electronic device measures a first voltage from upstream of the charging circuit and/or the bypass circuit with both the charging circuit and the bypass circuit turned off. In one or more embodiments of the present disclosure, the bypass circuit may be turned off or switched off by the controller turning off the first switch connected in series with the bypass circuit, and the charging circuit may be turned off or switched off by the controller turning off the second switch connected in series with the charging circuit.

The process then proceeds to S44, where the controller of the electronic device measures a second voltage from upstream of the charging circuit and/or the bypass circuit with the charging circuit turned off and the bypass circuit turned on. In one or more embodiments of the present disclosure, the bypass circuit may be turned on by the controller turning on the first switch connected in series with the bypass circuit, and the charging circuit may be turned off or switched off by the controller turning off the second switch connected in series with the charging circuit.

In one or more embodiments of the present disclosure, Steps S43 and S44 are performed within the predetermined time period when the electronic device receives a constant voltage from an external charging device. Steps S43 and S44 may be performed in any order. For instance, in some embodiments, step S43 may be performed before step S44 while in some other embodiments, step S44 may be performed before step S43.

The process then proceeds to S45, where the measured first voltage is compared with the measured second voltage. In one or more embodiments of the present disclosure, a difference between the first voltage and the second voltage is calculated or obtained by subtracting the second voltage from the first voltage.

The process then proceeds to S46, where a charging conductivity between the electronic device and the charging device is determined based on the comparison result obtained in step S45. In one or more embodiments of the present disclosure, the charging conductivity may be determined to be in one of several predefined conditions, such as two or three conditions, based on the comparison result. For example, the charging conductivity may be determined to be in a first, second, or third condition. The first condition may indicate that the charging conductivity is in a favorable condition. The second condition may indicate that the charging conductivity is in a less favorable condition, and the user of the electronic device may be notified or informed to clean the charging contacts of the electronic device and the charging device, (e.g., with alcohol). The third condition may indicate that the charging conductivity is in a poor condition, prompting the user of the electronic device to immediately clean the charging contacts of the electronic device and the charging device.

In one or more embodiments of the present disclosure, a respective indication or notification may be provided when the charging conductivity is determined to be in one of the predefined conditions. For example, a first indication or notification may be provided when the charging conductivity is determined to be in the first condition, a second indication or notification for the second condition, and a third indication or notification for the third condition. In one or more embodiments of the present disclosure, the first indication may be a green light emitted by an indication light on the electronic device or the charging device, the second indication may be a yellow light emitted by the indication light, and the third indication may be a red light emitted by the indication light. Alternatively, the first, second, and third indications may be green, yellow, and red indications or notifications displayed on an APP of the user of the earbud assembly.

In one or more embodiments of the present disclosure, the method, such as steps S42-S44, may be performed immediately after the electronic device is electrically connected to the charging device. For example, in one or more embodiments where the electronic device is a pair of TWS earbuds and the charging device is a charging case for the earbuds, the method, such as steps S42-S44, may be performed immediately after the earbuds are stowed in the charging case. In one or more other embodiments, the method may be performed at any suitable time, such as during or at the end of a charging process. The method may also be performed periodically with any suitable periodicity, such as once a day or once every two days.

FIG. 4B shows a flowchart of a method of the step S46 according to one or more embodiments of the present disclosure. The process begins at S462, where it is determined whether the voltage difference between the first voltage and the second voltage obtained from step S45 exceeds a first threshold. If the determination result of S462 is no, the process proceeds to S463 where it is determined that the conductivity is in a first condition. If the determination result of S462 is yes, the process proceeds to S464, where it is further determined whether the voltage difference exceeds a second threshold which is larger than the first threshold. If the result of S464 is no, the process proceeds to S465, where it is determined that the conductivity is in a second condition. If the determination result of S464 is yes, then the process proceeds to S466, where it is determined that the charging conductivity is in a third condition.

FIG. 4C shows a flowchart of a method of the step S46 according to one or more further embodiments of the present disclosure. The process begins at S461′ where the path impedance is calculated based on the voltage difference between the first voltage and the second voltage obtained from step S45. The process then proceeds to step S462′ where it is determined whether or not the path impedance exceeds a first threshold. If the determination result of S462′ is no, the process proceeds to S463′ where it is determined that the conductivity is in a first condition. If the determination result of S462′ is yes, the process proceeds to S464′, where it is further determined whether or not the path impedance exceeds a second threshold, which is larger than the first threshold. If the result of S464′ is no, the process proceeds to S465′, where it is determined that the conductivity is in a second condition. If the determination result of S464′ is yes, then the process proceeds to S466′, where it is determined that the charging conductivity is in a third condition.

The charging devices shown in FIGS. 1A-1B, 2, and 3 may use the methods shown in FIGS. 4A-4C to determine their charging conductivity. Therefore, the description discussed in reference to the embodiments of FIGS. 1A-1B, 2, and 3 can be applied to the methods of FIGS. 4A-4C. On the other hand, the description discussed in reference to the embodiments of FIGS. 4A-4C can be applied to the electronic devices of FIGS. 1A-1B, 2, and 3.

According to one or more embodiments of the disclosure, the present disclosure can be implemented as follows.

Item 1: An electronic device, comprising:
a charging circuit adapted to receive a charging voltage from an
external charging device, and to charge a battery of the electronic device with the received charging voltage;
a bypass circuit connected in parallel with the charging circuit, the bypass circuit comprising a resistor; and
a controller configured to selectively turn on or turn off the bypass circuit with a first switch connected in series with the bypass circuit and to selectively turn on or turn off the charging circuit with a second switch connected in series with the charging circuit, the controller being further configured to:
measure a first voltage from upstream of the charging circuit with both the bypass circuit and the charging circuit being turned off;
measure a second voltage from upstream of the charging circuit with the bypass circuit being turned on and the charging circuit being turned off;
compare the first voltage with the second voltage; and
determine a charging conductivity based on the comparison result.

Item 2: The electronic device of Item 1, wherein the controller is further configured to:
determine the charging conductivity to be in a first condition if a voltage difference between the first voltage and the second voltage is no larger than a first voltage threshold, and
determine the charging conductivity to be in a second condition if the voltage difference is larger than the first voltage threshold.

Item 3: The electronic device of any one of Items 1-2, wherein the controller is further configured to:
determine the charging conductivity to be in a first condition if a voltage difference between the first voltage and the second voltage is no larger than a first voltage threshold,
determine the charging conductivity to be in a second condition if the voltage difference is larger than the first voltage threshold but no larger than a second voltage threshold which is larger than the first voltage threshold, and
determine the charging conductivity to be in a third condition if the voltage difference is larger than the second voltage threshold.

Item 4: The electronic device of any one of Items 1-3, wherein the controller is further configured to calculate a charging path impedance based on the comparison result, and to:
determine the charging conductivity to be in a first condition if the charging path impedance is no larger than a first impedance threshold,
determine the charging conductivity to be in a second condition if the charging path impedance is larger than a first impedance threshold.

Item 5: The electronic device any one of Items 1-4, wherein the controller is further configured to calculate a charging path impedance based on the comparison result, and to:
determine the charging conductivity to be in a first condition if the charging path impedance is no larger than a first impedance threshold,
determine the charging conductivity to be in a second condition if the charging path impedance is larger than the first impedance threshold but no larger than a second impedance threshold which is larger than the first impedance threshold,
determine the charging conductivity to be in a third condition if the charging path impedance is larger than the second impedance threshold.

Item 6: The electronic device of any one of Items 1-5, wherein the controller is further configured to provide a notification to notify a user of the electronic device of the determined charging conductivity.

Item 7: The electronic device of any one of Items 1-6, further comprising a first charging contact and a second charging contact adapted to contact and to establish an electrical connection with corresponding contacts of the external charging device,
wherein the bypass circuit is electrically connected between the first charging contact and the second charging contact when the first switch is turned on, and the charging circuit is electrically connected between the first charging contact and the second charging contact when the second switch is turned on.

Item 8: The electronic device of any one of Items 1-7, wherein the electronic device is a TWS earbud.

Item 9: The electronic device of any one of Items 1-8, wherein the first switch is an N-type MOS and/or the second switch is a P-type MOS.

Item 10: An electronic assembly, comprising an electronic device of any one of Items 1-9 and a charging device, the charging device being adapted to charge the electronic device.

Item 11: The electronic assembly of Item 10, wherein the electronic device is a pair of TWS earbuds and the charging device is a charging case.

Item 12: The electronic assembly of any one of Items 10-11, wherein the charging device is configured to provide a constant voltage for a time period and the first voltage and the second voltage are measured within the time period.

Item 13: A method for determining a charging conductivity of an electronic device, comprising the steps of:
providing an electronic device comprising a charging circuit, a bypass circuit having a resistor and connected in parallel with the charging circuit, and a controller configured to selectively turn off or turn on the charging circuit and the bypass circuit;
receiving a charging voltage from an external charging device by the electronic device;
measuring a first voltage from upstream of the charging circuit with both the charging circuit and the bypass circuit being turned off;
measuring a second voltage from upstream of the charging circuit with the charging circuit being turned off and the bypass circuit being turned on;
comparing the first voltage with the second voltage;
determining the charging conductivity based on the comparison result.

Item 14: The method of Item 13, further comprising:
determining the charging conductivity to be in a first condition if a voltage difference between the first voltage and the second voltage is no larger than a first voltage threshold;
determining the charging conductivity to be in a second condition if the voltage difference is larger than the first voltage threshold.

Item 15: The method of any one of Items 13-14, further comprising:
determining the charging conductivity to be in a first condition if a voltage difference between the first voltage and the second voltage is no larger than a first voltage threshold,
determining the charging conductivity to be in a second condition if the voltage difference is larger than a first voltage threshold but no larger than a second voltage threshold, which is larger than the first voltage threshold, and
determining the charging conductivity to be in a third condition if the voltage difference is larger than the second voltage threshold.

Item 16: The method of any one of Items 13-15, further comprising:
calculating a charging path impedance based on the comparison result;
determining the charging conductivity to be in a first condition if the charging path impedance is no larger than a first impedance threshold; and
determining the charging conductivity to be in a second condition if the charging path impedance is larger than a first impedance threshold.

Item 17: The method of any one of Items 13-16, further comprising:
calculating a charging path impedance based on the comparison result;
determining the charging conductivity to be in a first condition if the charging path impedance is no larger than a first impedance threshold,
determining the charging conductivity to be in a second condition if the charging path impedance is larger than the first impedance threshold but no larger than a second impedance threshold, which is larger than the first impedance threshold,
determining the charging conductivity to be in a third condition if the charging path impedance is larger than the second impedance threshold.

Item 18: The method of any one of Items 13-17, further comprising providing a notification to notify a user of the electronic device of the determined charging conductivity.

Item 19: The method of any one of Items 13-18, wherein
the step of receiving a charging voltage comprising receiving a constant charging voltage from the external charging device for a time period,
wherein the steps of measuring the first voltage and measuring the second voltage are performed within the time period.

Item 20: The method of any one of Items 13-19, the steps of measuring the first voltage and measuring the second voltage are performed immediately after the electronic device is electrically connected to the charging device.

Item 21: The method of any one of Items 13-20, wherein the electronic device comprises a first switch connected in series with the bypass circuit and a second switch connected in series with the charging circuit, the bypass circuit being turned on or turned off by the controller turning on or turning off the first switch, and the charging circuit being turned on or turned off by the controller turning on or turning off the second switch.

Item 22: The method of any one of Items 13-21, wherein the electronic device is a pair of TWS earbuds and the charging device is a charging case for the pair of TWS earbuds.

Systems and methods have been described in general terms as an aid to understanding details of the disclosure. In some instances, well-known structures, materials, and/or operations have not been specifically shown or described in detail to prevent obscuring aspects of the disclosure. In other instances, specific details have been given to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the disclosure. Accordingly, the disclosure is not to be restricted except considering the attached claims and their equivalents.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electronic device, comprising:
a charging circuit adapted to receive a charging voltage from an external charging device, and to charge a battery of the electronic device with the received charging voltage;
a bypass circuit connected in parallel with the charging circuit, the bypass circuit comprising a resistor; and
a controller configured to selectively turn on or turn off the bypass circuit with a first switch connected in series with the bypass circuit and to selectively turn on or turn off the charging circuit with a second switch connected in series with the charging circuit, the controller being further configured to:
measure a first voltage from upstream of the charging circuit with both the bypass circuit and the charging circuit being turned off;
measure a second voltage from upstream of the charging circuit with the bypass circuit being turned on and the charging circuit being turned off;
compare the first voltage with the second voltage; and
determine a charging conductivity based on a comparison result.

2. The electronic device of claim 1, wherein the controller is further configured to:
determine the charging conductivity to be in a first condition if a voltage difference between the first voltage and the second voltage is no larger than a first voltage threshold, and
determine the charging conductivity to be in a second condition if the voltage difference is larger than the first voltage threshold.

3. The electronic device of claim 1, wherein the controller is further configured to:
determine the charging conductivity to be in a first condition if a voltage difference between the first voltage and the second voltage is no larger than a first voltage threshold,
determine the charging conductivity to be in a second condition if the voltage difference is larger than the first voltage threshold but no larger than a second voltage threshold which is larger than the first voltage threshold, and
determine the charging conductivity to be in a third condition if the voltage difference is larger than the second voltage threshold.

4. The electronic device of claim 1, wherein the controller is further configured to calculate a charging path impedance based on the comparison result, and to:
determine the charging conductivity to be in a first condition if the charging path impedance is no larger than a first impedance threshold, and
determine the charging conductivity to be in a second condition if the charging path impedance is larger than a first impedance threshold.

5. The electronic device of claim 1, wherein the controller is further configured to calculate a charging path impedance based on the comparison result, and to:
determine the charging conductivity to be in a first condition if the charging path impedance is no larger than a first impedance threshold,
determine the charging conductivity to be in a second condition if the charging path impedance is larger than the first impedance threshold but no larger than a second impedance threshold which is larger than the first impedance threshold, and
determine the charging conductivity to be in a third condition if the charging path impedance is larger than the second impedance threshold.

6. The electronic device of claim 1, wherein the controller is further configured to provide a notification to notify a user of the electronic device of the determined charging conductivity.

7. The electronic device of claim 1, further comprising a first charging contact and a second charging contact adapted to contact and to establish an electrical connection with corresponding contacts of the external charging device,
wherein the bypass circuit is electrically connected between the first charging contact and the second charging contact when the first switch is turned on, and the charging circuit is electrically connected between the first charging contact and the second charging contact when the second switch is turned on.

8. The electronic device of claim 1, wherein the electronic device is a TWS earbud.

9. The electronic device of claim 1, wherein the first switch is an N-type MOS and/or the second switch is a P-type MOS.

10. An electronic assembly, comprising an electronic device of claim 1 and a charging device, the charging device being adapted to charge the electronic device.

11. The electronic assembly of claim 10, wherein the electronic device is a pair of TWS earbuds and the charging device is a charging case.

12. The electronic assembly of claim 10, wherein the charging device is configured to provide a constant voltage for a time period and the first voltage and the second voltage are measured within the time period.

13. A method for determining a charging conductivity of an electronic device, comprising the steps of:
providing an electronic device comprising a charging circuit, a bypass circuit having a resistor and connected in parallel with the charging circuit, and a controller configured to selectively turn off or turn on the charging circuit and the bypass circuit;
receiving a charging voltage from an external charging device by the electronic device;
measuring a first voltage from upstream of the charging circuit with both the charging circuit and the bypass circuit being turned off;
measuring a second voltage from upstream of the charging circuit with the charging circuit being turned off and the bypass circuit being turned on;
comparing the first voltage with the second voltage; and
determining the charging conductivity based on a comparison result.

14. The method of claim 13, further comprising:
determining the charging conductivity to be in a first condition if a voltage difference between the first voltage and the second voltage is no larger than a first voltage threshold; and
determining the charging conductivity to be in a second condition if the voltage difference is larger than the first voltage threshold.

15. The method of claim 13, further comprising:
determining the charging conductivity to be in a first condition if a voltage difference between the first voltage and the second voltage is no larger than a first voltage threshold,
determining the charging conductivity to be in a second condition if the voltage difference is larger than a first voltage threshold but no larger than a second voltage threshold, which is larger than the first voltage threshold, and
determining the charging conductivity to be in a third condition if the voltage difference is larger than the second voltage threshold.

16. The method of claim 13, further comprising:
calculating a charging path impedance based on the comparison result;
determining the charging conductivity to be in a first condition if the charging path impedance is no larger than a first impedance threshold; and
determining the charging conductivity to be in a second condition if the charging path impedance is larger than a first impedance threshold.

17. The method of claim 13, further comprising:
calculating a charging path impedance based on the comparison result;
determining the charging conductivity to be in a first condition if the charging path impedance is no larger than a first impedance threshold,
determining the charging conductivity to be in a second condition if the charging path impedance is larger than the first impedance threshold but no larger than a second impedance threshold, which is larger than the first impedance threshold, and
determining the charging conductivity to be in a third condition if the charging path impedance is larger than the second impedance threshold.

18. The method of claim 13, further comprising providing a notification to notify a user of the electronic device of the determined charging conductivity.

19. The method of claim 13, wherein the step of receiving a charging voltage comprising receiving a constant charging voltage from the external charging device for a time period, the steps of measuring the first voltage and measuring the second voltage are performed within the time period.

20. The method of claim 13, the steps of measuring the first voltage and measuring the second voltage are performed immediately after the electronic device is electrically connected to the charging device.

21. The method of claim 13, wherein the electronic device comprises a first switch connected in series with the bypass circuit and a second switch connected in series with the charging circuit, the bypass circuit being turned on or turned off by the controller turning on or turning off the first switch, and the charging circuit being turned on or turned off by the controller turning on or turning off the second switch.

22. The method of claim 13, wherein the electronic device is a pair of TWS earbuds and the charging device is a charging case for the pair of TWS earbuds.
